(19) United States
(12) Patent Application Publication
(10) Pub. No.: US 2017/0167180 A1
(43) Pub. Date: Jun. 15, 2017

(54) HANDS-FREE REAR VECHICLE ACCESS SYSTEM AND IMPROVEMENTS THERETO

(71) Applicant: ADAC PLASTIC, INC., Grand Rapids, MI (US)

(72) Inventors: Robert Bingle, Walker, MI (US); Keith J. Vadas, Caledonia, MI (US); Thomas Merlyn French, Rockford, MI (US)

(21) Appl. No.: 15/378,823

(22) Filed: Dec. 14, 2016

Related U.S. Application Data
(60) Provisional application No. 62/266,917, filed on Dec. 14, 2015.

(51) Int. Cl. E05F 15/73; G01J 5/00; G01J 5/10

(52) U.S. Cl. CPC E05F 15/73; G01J 5/10; G01J 5/0025; E05F 2015/765; E05Y 2900/532

(57) ABSTRACT

A vehicle access system includes: an infrared detector assembly for detecting an object within a sensing region of the infrared detector assembly; at least one controller operatively connected to the infrared detector assembly, the at least one controller operative (i) to determine from inputs from the infrared detector assembly if a detected object exhibits a predefined gesture and, if the detected object exhibits a predefined gesture, (ii) to direct the execution of one or more pre-defined vehicle commands; and a plurality of lights operatively connected to the at least one controller, the plurality of lights selectively illuminable to produce visible light in one or more colors, wherein one or more of the plurality lights (i) are selectively illuminated by the at least one controller to visibly indicate the detected presence of an object within the sensing region by the infrared detector assembly, and (ii) are selectively illuminated by the at least one controller to visibly indicate that the detected object exhibits a predefined gesture.

### CROSS-REFERENCE TO RELATED APPLICATION

The present application is related to, and claims the benefit of priority from, U.S. Provisional Application Ser. No. 62/266917, filed 14 Dec. 2015, the disclosure of which is incorporated herein by reference in its entirety.

### TECHNICAL FIELD OF THE INVENTION

The present invention relates to vehicle access systems and, more particularly, to hands-free type vehicle access systems in which infrared light is used to detect motions exhibited by an object (e.g., a user's hand, foot, etc.), and to effect one or more vehicle commands (e.g., locking or unlocking a vehicle closure, opening a vehicle closure, activating exterior or interior illumination, etc.) when a predefined motion is detected.

### BACKGROUND OF THE INVENTION

Many vehicles today are equipped with a passive entry system, or “PES” for short. The PES provides communication between a key fob and a computer of the vehicle for automatically locking and unlocking the vehicle in response to detection of the key fob being in close proximity to the vehicle. This allows an operator of the vehicle to approach the vehicle and open the door without having to manually unlock the door with a key or even press a button on the key fob. Likewise, the PES is configured to automatically lock the vehicle in response to the detection of the key fob leaving the proximity of the vehicle.

Many times an operator approaches the vehicle with their hands full of items such as groceries, tools, etc. In such a situation, it is desirable to be able to open a closure of the vehicle, e.g., a passenger door, a trunk, or a lift gate, without setting down the items. Although systems have been developed to work with the PES to allow an operator to open the closure without freeing their hands, such systems are known to be complex, awkward, and not intuitive for operators.

Among known hands-free vehicle access systems are those employing infrared (“IR”) detector assemblies. Typically, such systems use an active near infrared arrangement in which multiple IR LEDs and one or more sensors are employed, with the one or more sensors calculating the distance of an object from each LED by timing the interval between emission and reception of the IR signals and, via a computer processor, interpreting the received information to determine movement within the IR field. Exemplary IR movement recognition systems are disclosed in US Patent Application Publication 20120200486, US Patent Application Publication 20150069249, and US Patent Application Publication 20120312956, and US Patent Application Publication 20150248796, the disclosures of which are incorporated herein by reference in their entireties.

### SUMMARY OF THE INVENTION

Disclosed herein is a vehicle access system, comprising: an infrared detector assembly for detecting an object within a sensing region of the infrared detector assembly; at least one controller operatively connected to the infrared detector assembly, the at least one controller operative (i) to determine from inputs from the infrared detector assembly if a detected object exhibits a predefined gesture and, if the detected object exhibits a predefined gesture, (ii) to direct the execution of one or more pre-defined vehicle commands; and a plurality of lights operatively connected to the at least one controller, the plurality of lights selectively illuminable to produce visible light in one or more colors, wherein one or more of the plurality lights (i) are selectively illuminated by the at least one controller to visibly indicate the detected presence of an object within the sensing region by the infrared detector assembly, and (ii) are selectively illuminated by the at least one controller to visibly indicate that the detected object exhibits a predefined gesture.

According to one aspect, the one or more of the plurality of lights are selectively illuminated in a first color to visibly indicate the detected presence of an object within the sensing region by the infrared detector assembly, and are selectively illuminated in a second color to visibly indicate that the detected object exhibits a predefined gesture.

In another aspect, the one or more of the plurality of lights are (i) selectively illuminated in a first color to visibly indicate the detected presence of an object within an area of the sensing region where the infrared detector assembly cannot determine if the detected object exhibits a predefined gesture, (ii) selectively illuminated in a second color to visibly indicate the detected presence of an object within an area of the sensing region where the infrared detector assembly can determine if the detected object exhibits a predefined gesture, and (iii) selectively illuminated in a third color to visibly indicate that the detected object exhibits a predefined gesture.

In one form of the invention, the first color of illumination is red, the second color is amber, and the third color is green.

The plurality of lights may comprise two, three, or more lights. The lights may, in one form of the invention, be RGB LEDs.

According to form of the invention, the infrared detector assembly comprises an array of infrared light-emitting LEDs and an array of infrared light sensors for receiving reflected light from an object in the sensing region in accordance with a time sequence in which one or more of the infrared light-emitting LEDs is activated and outputting a plurality of reflected signals, and the plurality of lights comprise a number of LEDs equal to the number of infrared light-emitting LEDs.

In one embodiment, the vehicle access system takes the form of a license plate bracket having a housing for engaging a vehicle and supporting a license plate against the vehicle; an infrared detector assembly, associated with the housing, for detecting an object within a sensing region of the infrared detector assembly; at least one controller associated with the housing and operatively connected to the infrared detector assembly, the controller operative (i) to determine from inputs from the infrared detector assembly if a detected object exhibits a predefined gesture and, if the detected object exhibits a predefined gesture, (ii) to direct the execution of one or more pre-defined vehicle commands; and a plurality of lights associated with the housing and operatively connected to the at least one controller, the plurality of lights selectively illuminable to produce visible light in one or more colors, wherein one or more of the plurality lights (i) are selectively illuminated by the at least one controller to visibly indicate the detected presence of an object within the sensing region by the infrared detector assembly, and (ii) are selectively illuminated by the at least one controller to visibly indicate that the detected object exhibits a predefined gesture.

According to one feature, the at least one controller is operatively connectable to the rear access closure of a vehicle, and the one or more pre-defined vehicle commands includes opening the rear access closure of the vehicle.

In another embodiment, the vehicle access system takes the form of a handle assembly for a vehicle access door, the handle assembly including a housing. Associated with the housing are each of: an infrared detector assembly for detecting an object within a sensing region of the infrared detector assembly; at least one controller associated with the housing and operatively connected to the infrared detector assembly, the at least one controller operative (i) to determine from inputs from the infrared detector assembly if a detected object exhibits a predefined gesture and, if the detected object exhibits a predefined gesture, (ii) to direct the execution of one or more pre-defined vehicle commands; and a plurality of lights associated with the housing and operatively connected to the at least one controller, the plurality of lights selectively illuminable to produce visible light in one or more colors, wherein one or more of the plurality lights (i) are selectively illuminated by the at least one controller to visibly indicate the detected presence of an object within the sensing region by the infrared detector assembly, and (ii) are selectively illuminated by the at least one controller to visibly indicate that the detected object exhibits a predefined gesture.

According to one feature of this embodiment, the at least one controller is operatively connectable to an access closure of a vehicle, and the one or more pre-defined vehicle commands includes locking and/or unlocking the access closure of the vehicle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic depiction of a vehicle access system according to the present invention;

FIG. 2 shows the invention as depicted in FIG. 1, and further depicts illumination of visible lights in response to detection of an object in the sensing region of the infrared detector assembly;

FIG. 3 shows the invention as depicted in FIG. 1, and further depicts illumination of visible lights in response to detection of an object in the sensing region of the infrared detector assembly;

FIG. 4 shows the invention as depicted in FIG. 1, and further depicts illumination of visible lights in response to the exhibition of a predefined gesture by the detected object;

FIG. 5 is a perspective view of an exemplary embodiment of the inventive vehicle access system in the form of a license plate bracket and sensor assembly connected to the rear end of a vehicle;

FIG. 6 is an exploded perspective side view of the license plate bracket and sensor assembly of FIG. 5;

FIG. 7 is a perspective cutaway side view of the license plate bracket and sensor assembly of FIG. 5;

FIG. 8 is a perspective top view of the license plate bracket and sensor assembly of FIG. 5, illustrating how a license plate may be received by a slot of the assembly;

FIG. 9 is a back perspective view of the license plate bracket and sensor assembly of FIG. 5;

FIG. 10 is a front perspective view of a back plate of the license plate bracket and sensor assembly of FIG. 5;

FIG. 11 is a front perspective view of the license plate bracket and sensor assembly of FIG. 5;

FIG. 12 is a back perspective view of a plate frame of the license plate bracket and sensor assembly of FIG. 5;

FIG. 13 is a back perspective view of a plurality of first ribbon wires and a jumper board of the license plate bracket and sensor assembly of FIG. 5;

FIG. 14 is a front perspective view of a second example embodiment of a license plate bracket and sensor assembly;

FIG. 15 is a perspective view of another exemplary embodiment of the inventive vehicle access system in the form of an access handle for a vehicle closure;

FIG. 16 is an exploded perspective view of the access handle of FIG. 15;

FIG. 17 is the exploded perspective view of FIG. 16, shown from another angle of view; and

FIG. 18 is a cross-sectional view of the access handle, taken along lines XVIII.

### WRITTEN DESCRIPTION

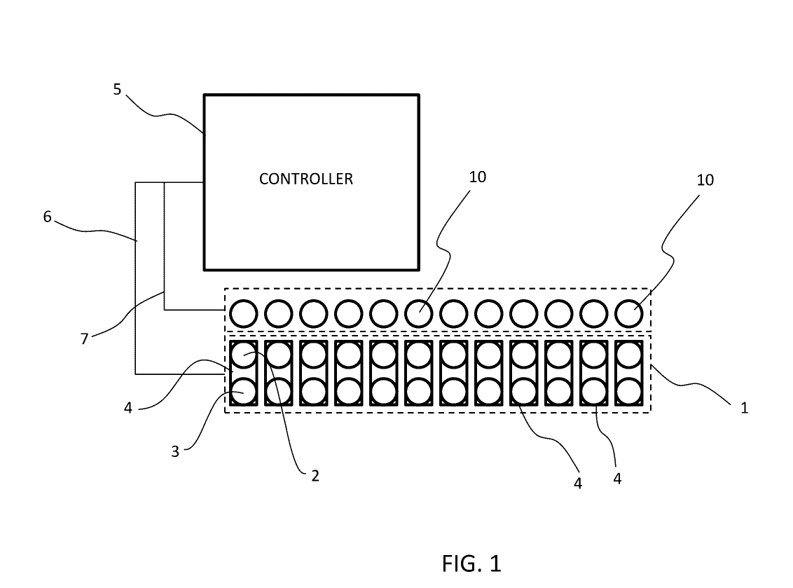

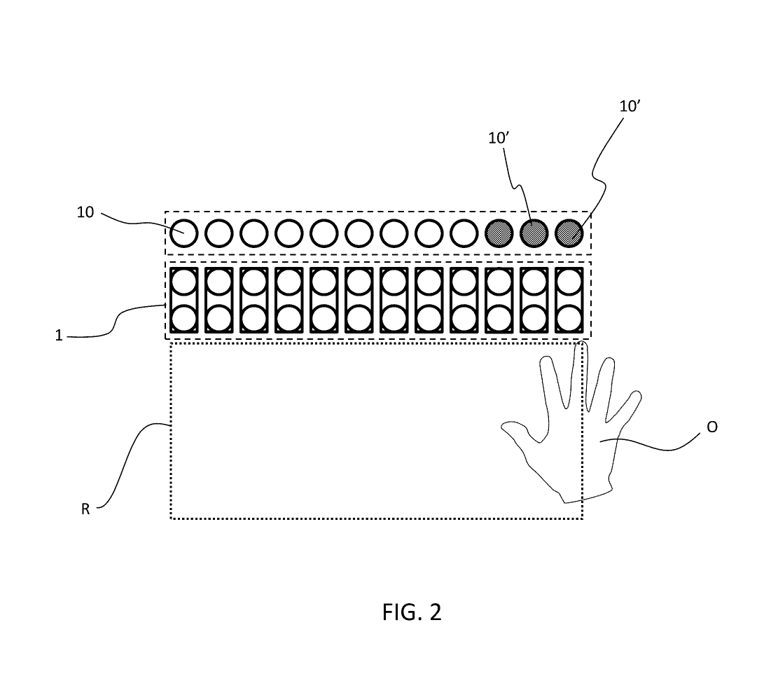

Referring to the drawings, and more particularly to FIGS. 1-4, the present invention most generally comprehends a vehicle access system comprising: an infrared (also referred to herein as “IR”) detector assembly (indicated schematically in the dashed box 1) for detecting an object within a sensing region R (depicted schematically in dashed lines in FIGS. 2-4) of the infrared detector assembly; at least one controller 5 operatively connected (indicated schematically by the solid line 6 to the infrared detector assembly, the at least one controller operative (i) to determine from inputs from the infrared detector assembly if a detected object exhibits a predefined gesture and, if the detected object exhibits a predefined gesture, (ii) to direct the execution of one or more pre-defined vehicle commands; and a plurality of lights 10 operatively connected to the at least one controller (as indicated schematically by the solid line 7), the plurality of lights selectively illuminable to produce visible light in one or more colors, wherein one or more of the plurality lights (i) are selectively illuminated by the at least one controller to visibly indicate the detected presence of an object within the sensing region by the infrared detector assembly, and (ii) are selectively illuminated by the at least one controller to visibly indicate that the detected object exhibits a predefined gesture.

As explained here and elsewhere herein, the term “controller” as used in this application is comprehensive of any computer, processor, microchip processor, integrated circuit, or any other element(s), whether singly or in multiple parts, capable of carrying programming for performing the functions specified in the claims and this written description. The at least one controller may be a single such element which is resident on a printed circuit board with the other elements of the inventive access system. It may, alternatively, reside remotely from the other elements of the access system. For example, but without limitation, the at least one controller may take the form of programming in the onboard computer of a vehicle comprising the access system of the present invention. The at least one controller may also reside in multiple locations or comprise multiple components. For instance, and without limitation, it is contemplated that certain aspects of the at least one controller, such as, by way of non-limiting example, determining from inputs from the infrared detector assembly if a detected object exhibits a predefined gesture, may be carried out by a first microprocessor, circuit, etc. which is disposed proximate the infrared detector assembly, while other aspects, such as (again by way of non-limiting example) directing the execution of one or more pre-defined vehicle commands, may be carried out by a second microprocessor, circuit, etc. (such as, for instance, the onboard computer of the vehicle in which the access system is included).

Per convention, the infrared detector assembly 1 may comprise an array of IR-light-emitting LEDs 2 and an array of infrared light sensors 3 for receiving reflected light from an object in the sensing region R in accordance with a time sequence in which one or more of the infrared light-emitting LEDs is activated and outputting a plurality of reflected signals. Conventionally, the LEDs 2 and sensors 3 are arranged in pairs (indicated schematically by the box 4), with one LED providing the infrared light for detection by an associated sensor.

As is known, such detector assemblies are associated with processors or computer controllers which are programmed to determine from the IR sensor inputs such things as, without limitation, (a) when an object has been detected in the sensing region R, (b) whether the object is of a predetermined type, and (c) whether the object has moved within the sensing region.

Exemplary IR detector systems are disclosed in US Patent Application Publication 20120200486, US Patent Application Publication 20150069249, US Patent Application Publication 20120312956, and US Patent Application Publication 20150248796, the disclosures of which are incorporated herein by reference in their entireties.

In the exemplary embodiments, the IR LEDs and sensors take the form of modules available from NEONODE, INC. (San Jose, Calif.). The modules typically contain multiple pairs of IR emitters and sensors for receiving reflected IR light. The modules have a range of about 200mm of off-surface detection and the pairs of emitters and sensors permits a higher resolution of detection. For instance, the array of IR LEDs and sensors is capable of detecting the difference between a single finger and multiple fingers. Consequently, the array of IR LEDs and sensors is capable of detecting gesturing by a user's hand, for instance.

The “object” whose motion is sensed is, in the exemplary embodiments, the hand of a user. By sensing and distinguishing among a variety of hand motions or gestures, and comparing such sensed motions against pre-defined motions (or, at least, their mathematical equivalents in terms of received signal profiles), the present invention permits users to communicate different intentions by varying the hand motions presented proximate the vehicle control apparatus. Of course, it will be understood that motion of objects other than a user's hand(s)—such as, for instance, feet—may be sensed in conjunction with the present invention.

In the exemplary embodiments, the infrared detector assembly 1 contemplates arrays of IR LEDs and sensors which are arranged linearly; i.e., in a continuous row. This is shown schematically in FIGS. 1-4. Of course, it will be appreciated that such an arrangement is not intended to be limiting of the present invention, according to which the arrays of IR LEDs and sensors may have a non-linear configuration.

In the exemplary embodiments, the plurality of lights 10 comprise visible-light LEDs equal in number to the number of infrared light-emitting LEDs 2. Moreover, the plurality of visible-light LEDs 10 are arranged to be coextensive with, and have the same overall shape (i.e., linear) as, the IR LEDS and sensors of the IR detector assembly. This is shown schematically in FIGS. 1-4. However, while it is disclosed herein that the visible lights are arranged linearly to match the number, configuration, and overall length of the arrays of IR LEDs and sensors, it is contemplated that other configurations and geometries will be possible, consistent with the purpose of providing positive feedback to a user of the access system; that is, the purpose of positively visually indicating for the user at least (i) that an object (e.g., a hand, foot, etc.) has been detected by the IR detector assembly and, further, (ii) that the detected object exhibits a predefined gesture (i.e., a gesture which effects a vehicle command such as, by way of non-limiting example, locking/unlocking a closure, opening a closure, turning on or off external or interior lighting, etc.).

In one contemplated embodiment, for instance, two lights 10 may be provided for producing the desired visible-light feedback. In this embodiment, one of the lights is selectively illuminated in a first color to visibly indicate the detected presence of an object within the sensing region by the infrared detector assembly, while the other of the lights is selectively illuminated in a second color to visibly indicate that the detected object exhibits a predefined gesture.

In still another contemplated embodiment, three lights 10 may be provided. In this embodiment, one of the lights is selectively illuminated in a first color to visibly indicate the detected presence of an object within an area of the sensing region where the infrared detector assembly cannot determine if the detected object exhibits a predefined gesture, another one of the lights is selectively illuminated in a second color to visibly indicate the detected presence of an object within an area of the sensing region where the infrared detector assembly can determine if the detected object exhibits a predefined gesture, and the third light is selectively illuminated in a third color to visibly indicate that the detected object exhibits a predefined gesture.

Of course, it is also contemplated that any number of lights 10 beyond two or three may also be employed to the same effect as described above. That is, multiple lights may be illuminated in one or more colors to provide the desired positive visual feedback.

It is also contemplated that the lights 10 may be LEDs and, as desired, RGB LEDs capable of illumination in more than one color. According to this variant, it will be appreciated that positive visual indication of operation of the IR detector assembly 1 may comprehend illumination in numerous colors, each such color indicative of a different state of operation of the access system. For instance, and without limitation, the color red may serve to indicate that the IR detector assembly has detected an object (e.g., a hand or foot) but cannot determine if the object is exhibiting a predefined gesture. For instance, the object may be insufficiently visible to the IR detector assembly. The color green, by contrast, may serve to indicate that the detected object is exhibiting a predefined gesture and, consequently, that the predefined vehicle command associated with that predefined gesture (e.g., unlocking the vehicle closure, opening the vehicle closure, etc.) is being effected. In addition to green, other colors might be uniquely associated with different predefined commands. Thus, while green illumination might reflect that a closure for the vehicle is being unlocked, blue light might reflect that a fuel door latch has been opened, purple may reflect that a window is being opened, etc.

With specific reference to FIGS. 2-4, operation of the access system according to the present invention is shown exemplified.

In a first state of operation, shown in FIG. 2, an object O—in this example, a user's hand—has entered the sensing region R of the IR detector assembly 1. Per the limitations of the IR detector assembly, however, the object is insufficiently positioned within the sensing region R for the IR detector assembly to determine if and when the object exhibits a predefined gesture. In consequence of this, the at least one controller (not shown in FIGS. 2-4) is programmed to effect illumination of at least some of the lights 10—in this example, a plurality of lights 10′ proximate the IR LED/sensor pairs which detected the object—in a first color to visually indicate to the user that the object is insufficiently positioned in the sensing region R. In this example, the lights 10′ are illuminated in the color red. Red serves as a generally universal indicator of warning and so is appropriate as a visual indicator to the user that the object is insufficiently positioned in the sensing region R. As noted above, however, one or more other colors may be employed as desired.

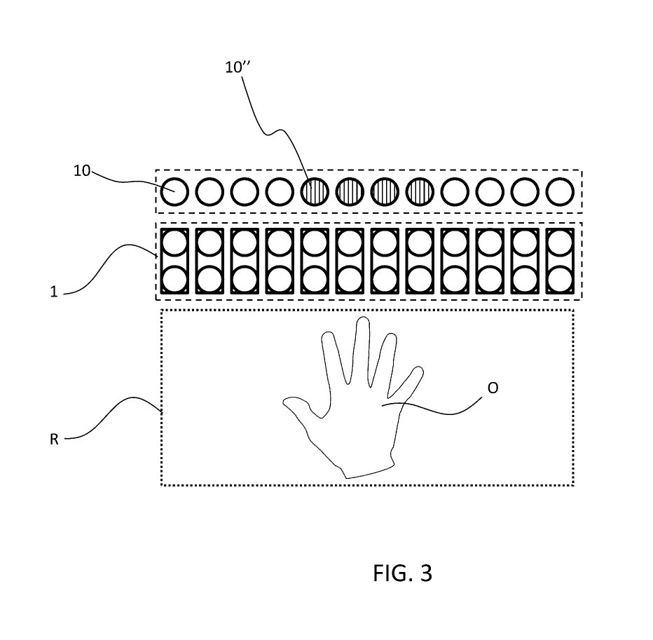

Responding to the visual feedback provided by illumination of the lights in FIG. 2, the user moves the object O leftward and, thus, further into the sensing region R. This is depicted in FIG. 3. In this position, the object O is sufficiently in the sensing region that the IR detector assembly 1 is capable of detecting whether and when the object O exhibits a predefined gesture. Visual feedback of this is provided to the user by the at least one controller's illumination of lights 10″, as shown. In this example, the illuminated lights 10″ are those proximate the IR LED/sensor pairs which detected the object—that is, those defining the approximate center of the sensing region R. The lights 10″ are illuminated in the color amber or amber, according to the exemplary embodiment. This serves as an indicator to the user that the object O is sufficiently positioned in the sensing region R that any subsequent gestures made by the object may be recognized by the at least one controller as predefined gestures. As noted above, however, one or more other colors may be employed as desired.

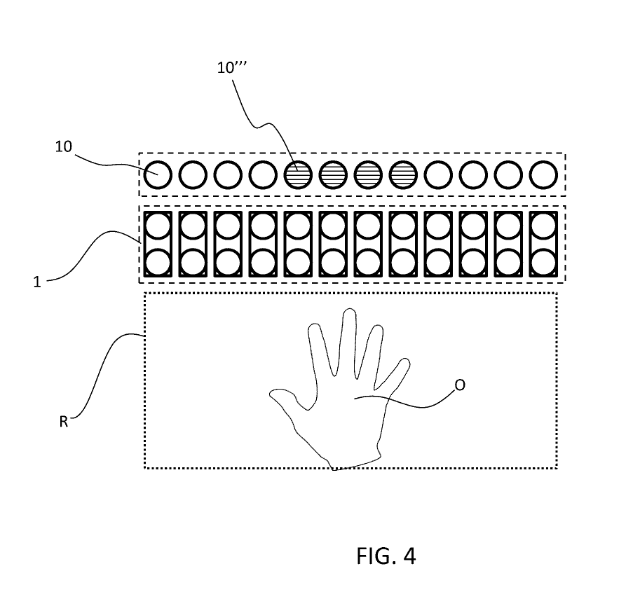

In the final exemplary illustration of operation, FIG. 4, the object O is shown in approximately the same position as in FIG. 3, but after a predefined gesture has been exhibited to, and determined by the at least one controller to correspond to, a predefined gesture. In consequence of the at least one controller's recognition of the exhibited gesture as corresponding to a predefined gesture, the at least one controller provides visual feedback of such recognition by effecting illumination of lights 10′″. Illumination in this instance is in the color green. Green serves as a generally universal indicator of acceptance and so is appropriate as a visual indicator to the user that the gesture has been recognized and the at least one controller has directed the execution of one or more predefined vehicle commands. As noted above, however, one or more other colors may be employed as desired.

While the foregoing example illustrates the selective lighting of several lights simultaneously, it will be appreciated that the number of lights illuminated in any given situation may be varied depending on the type of feedback desired, the number of lights being employed in the system, etc. Likewise, the illumination need not be static; that is, the lights may be sequentially illuminated to render the feedback more noticeable to the user, to direct the user to move the object in a desired direction, etc.

The manner of the at least one controller's directing the execution of one or more vehicle commands will be understood by those skilled in the art to be conventional. In brief, however, the at least one controller is, in use, operatively connected to the appropriate one or ones of the vehicle's onboard computers, such as the body control module, for instance. Upon determining from the sensor inputs via the IR detector assembly that a predefined gesture has been exhibited, the at least one controller instructs the vehicle's computer to effect the desired operation (e.g., to unlock or lock a closure—such as a door, tailgate, etc.; to open a closure—such as a tailgate, etc.; to turn on interior and/or exterior vehicle lighting, etc.).

It will also be appreciated that power for the access system of the present invention may be provided via the vehicle's onboard power system; that is, the same system which powers other electronics and electromechanical systems such as the vehicle locks, key-fob challenge transmissions, etc. Alternatively, or in addition, a local power source—i.e., a dedicated battery or batteries—may be provided.

In the illustrated embodiments, the at least one controller, plurality of lights, and IR detector assembly may all reside on a single printed circuit board (“PCB”). Alternatively, they may be separate components which are integrated in known fashion to define a unit. For instance, it is contemplated that the at least one controller may reside on the vehicle's onboard computer; that is, it may part of the programming of the vehicle's onboard computer and operatively connected to the IR detector assembly and plurality of lights.

It will be appreciated by those skilled in the art that the one or more pre-defined vehicle commands may be any commands that can be effected by the at least one controller via the electronic or electromechanical systems of a vehicle, including locking/unlocking closures (e.g., doors), turning on/turning off exterior and/or interior vehicle lights, opening and/or closing windows, etc.

It is contemplated that the present inventive vehicle access system may be employed in conjunction with existing vehicle access systems such as intelligent “key fob”-type remotes used in PES-type access systems. According to convention, such access systems may operate by issuing a short-range “challenge” signal to a “key fob” remote carried by a user. If the “key fob” remote is one that is authorized for the vehicle, the “challenge” response from the remote results in the vehicle being placed in a mode where it will accept subsequent “commands” from the user, such as unlocking or locking the vehicle. The present access system may be operatively connected to the vehicle's onboard electronics so as to permit operation only in circumstances when an authorized user seeks to use the system. Alternatively, the access system of the present invention my further include the necessary components to enable independent authentication of the user; that is, the electronics and hardware necessary to issue a challenge signal and to receive and evaluate the response from a user's key fob.

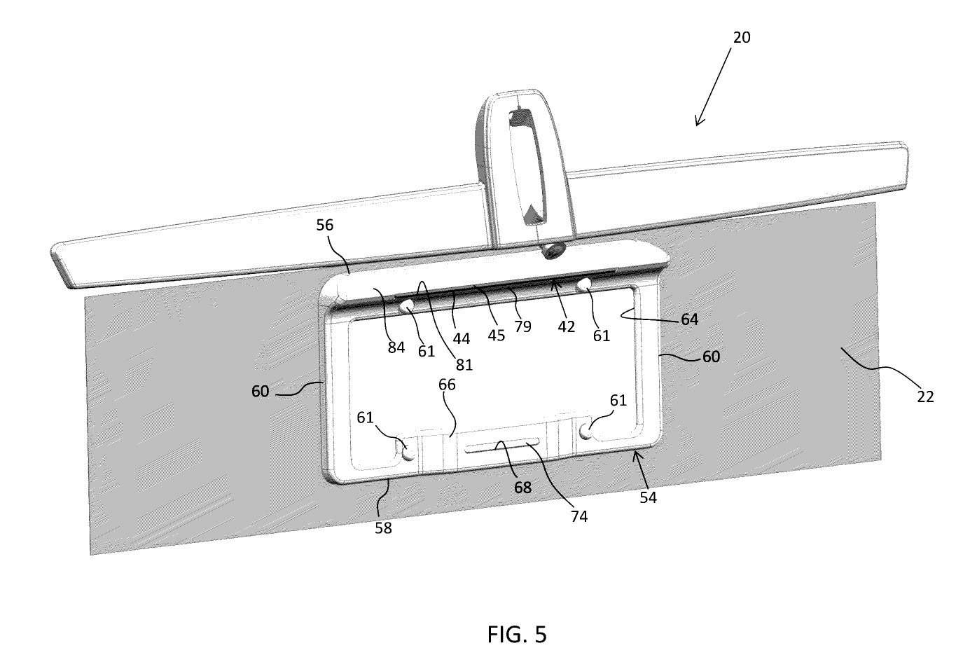

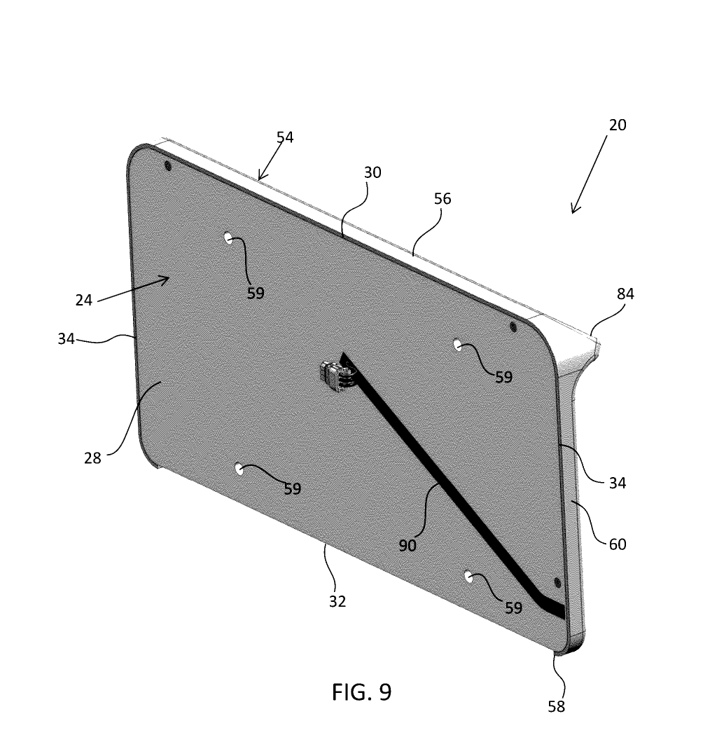

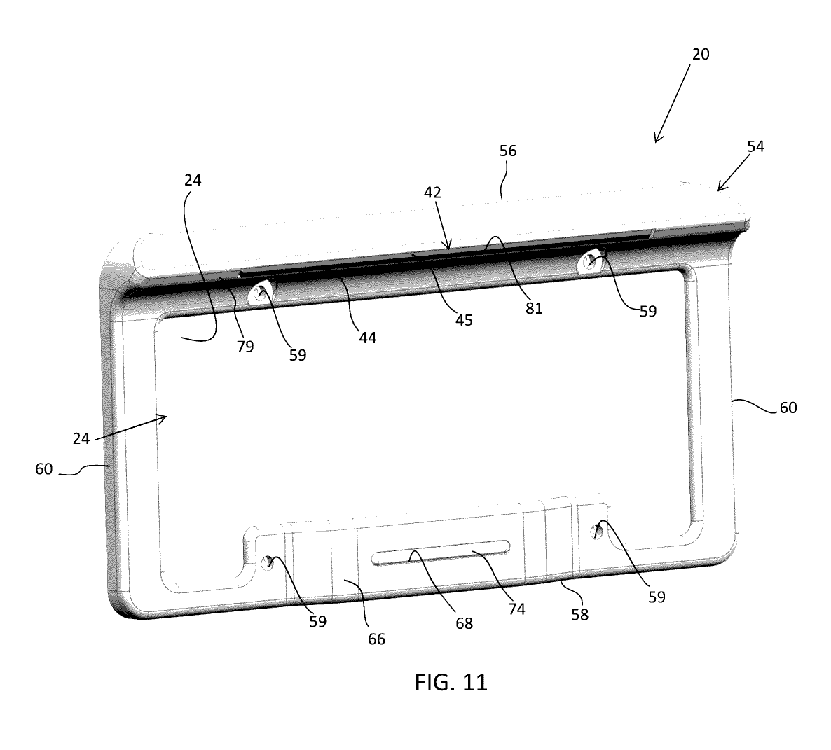

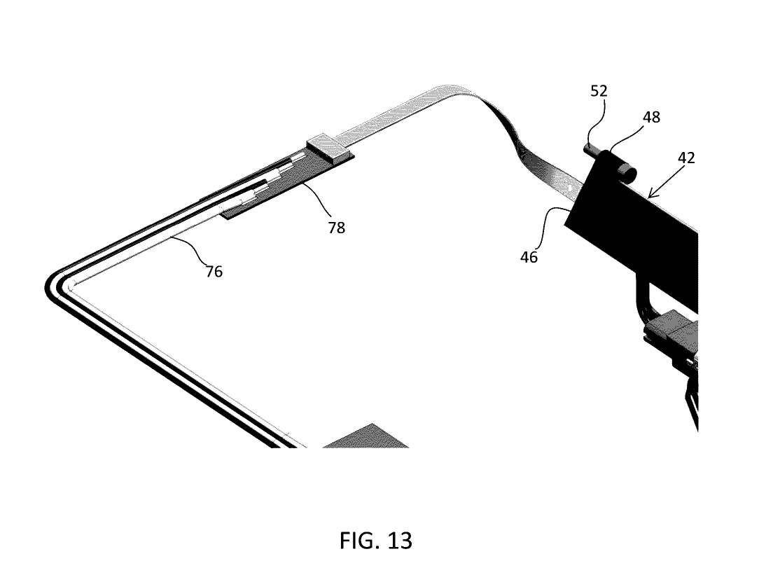

The vehicle access system as described above may be embodied in a vehicle in any number of ways. For instance, and without limitation, the system may be embodied in a vehicle access handle (e.g., a door handle), in an access interface positioned in the B-pillar proximate the driver's-side door, in a trim component proximate a rear cargo door, etc. In one embodiment, shown in FIGS. 5-15, the present invention may be seen to take the form of a license plate bracket and sensor assembly 20, 20′ for providing hands-free access to a rear access door of a vehicle 22. It should be appreciated that the term “rear access door” as used herein may include any rear access door such as, but not limited to, a lift gate, trunk and tailgate. Additionally, the term “vehicle” as used herein may encompass various types of vehicles including, but not limited to, automobiles and all-terrain vehicles

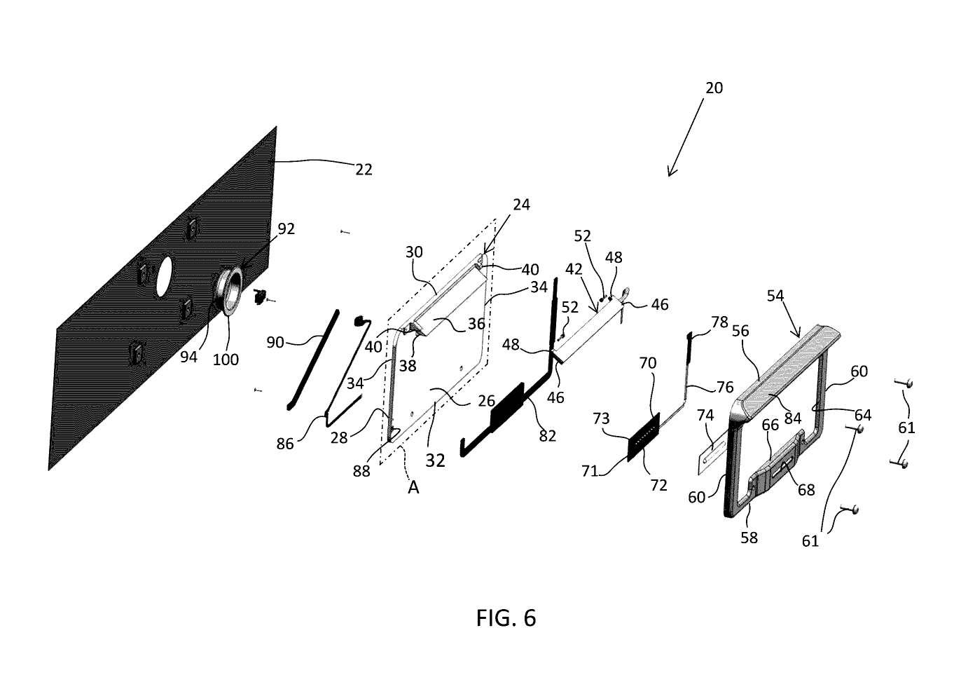

With specific reference to FIG. 6, the assembly 20 includes a generally rectangular-shaped back plate 24 that extends along a plane A. The back plate 24 presents a front surface 26, a rear surface 28, a top 30, a bottom 32 and a pair of sides 34 that extend between the top 30 and bottom 32. It should be appreciated that the back plate 24 could have other shapes, such as, but not limited to, an oval shape.

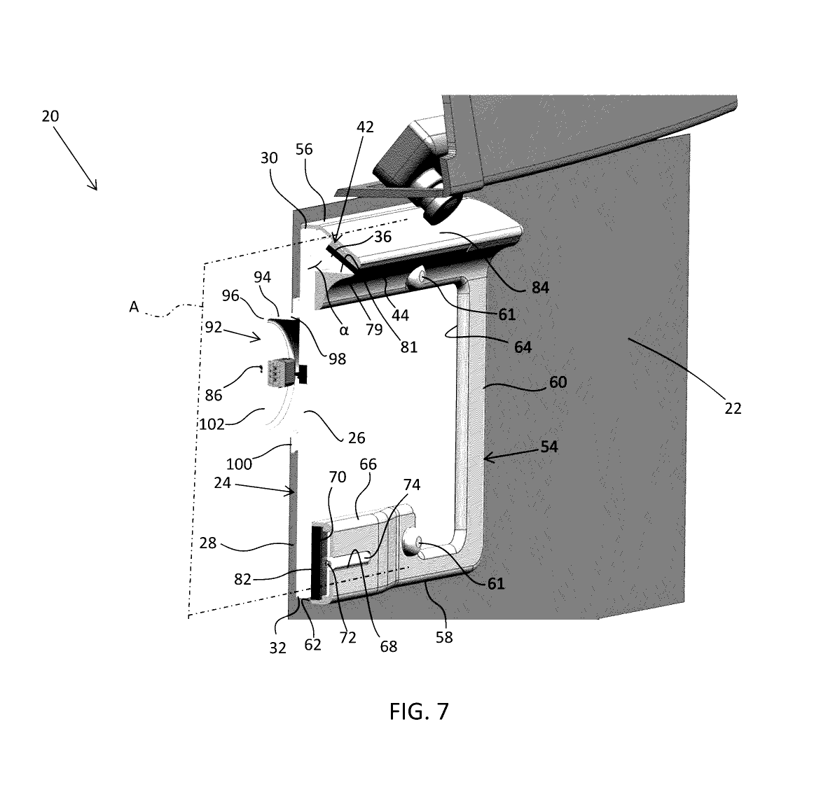

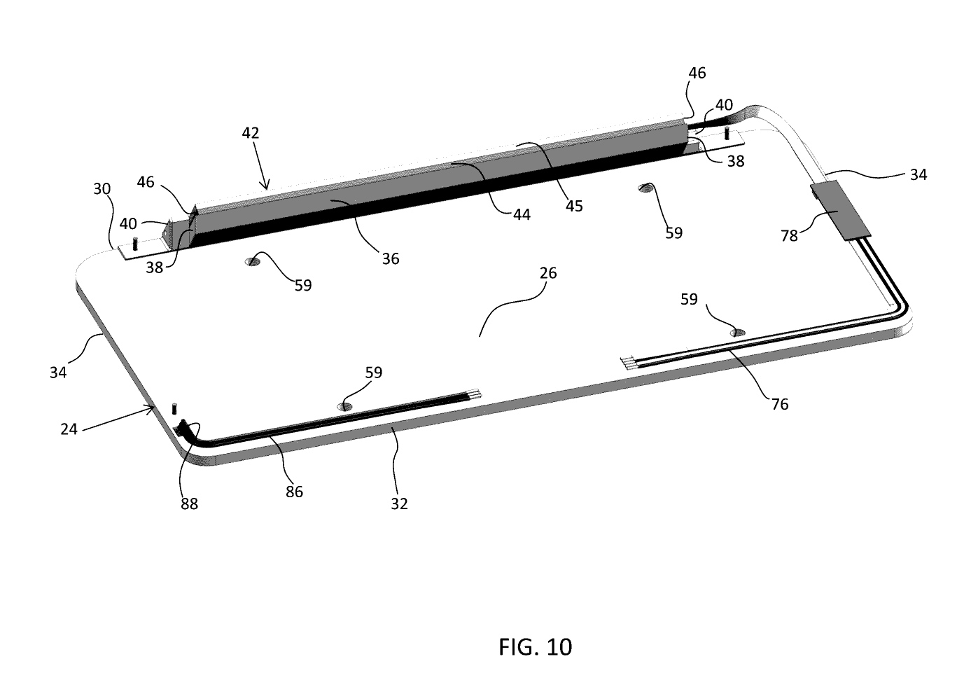

As best shown in FIG. 7, a first flange 36 extends from the top 30 of the back plate 24 over the front surface 26 at a viewing angle a. The viewing angle a is acute relative to the plane A of the back plate 24. As best shown in FIG. 10, the first flange 36 extends between a pair of edges 38 that are spaced inwardly from the sides 34 of the back plate 24. A protrusion 40 extends transversely from the front surface 26 of the back plate 24 adjacent to each of the edges 38 of the first flange 36.

An IR detector assembly 42 overlies the first flange 36. The detector assembly 42 includes an array of IR LED/sensor pairs 44 at the viewing angle a relative to the plane A for detecting movement in a sensing region in front of the detector assembly. It should be appreciated that since the viewing angle α is acute relative to the plane A of the back plate 24, once the assembly 20 is connected to the vehicle 22, the array 44 is pointed generally toward the feet of an operator that is standing behind the vehicle 22, thus allowing the array 44 to detect movement in the region of the feet of the operator.

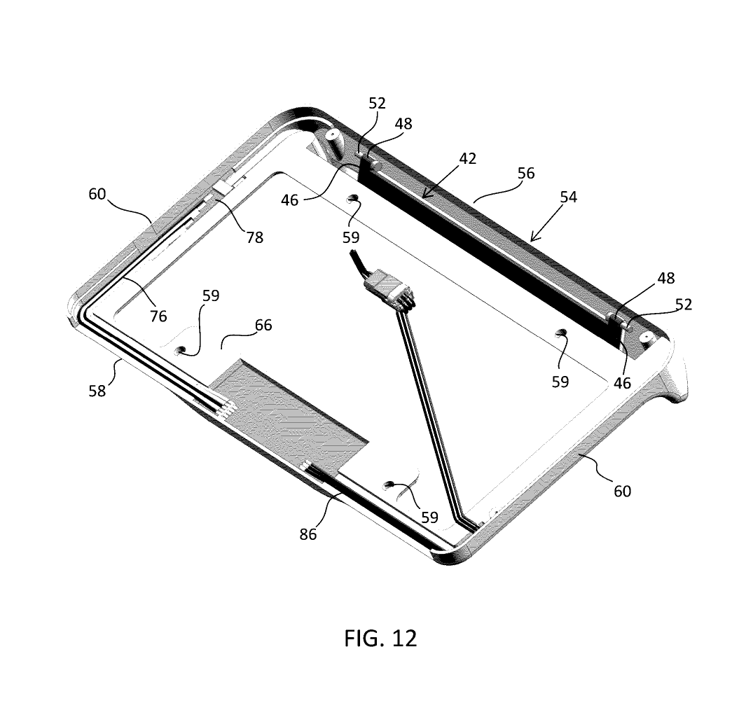

As best shown in FIGS. 10 and 12, the IR detector assembly 42 extends between a pair of extremities 46, with each of the extremities 46 aligned with one of the edges 38 of the first flange 36. A pair of tabs 48 extend away from the detector assembly 42, each aligned with one of the extremities 46 and disposed against one of the protrusions 40. A pair of first fasteners 52 each extend through one of the tabs 48 and one of the protrusions 40 to secure the detector assembly 42 to the first protrusions 40. In the example embodiment, the first fasteners 52 are bolts, however, it should be appreciated that they could be other types of fasteners including, but not limited to, screws or adhesives.

As best shown in FIGS. 5-8, a plate frame 54 overlies the back plate 24. The plate frame 54 has a generally rectangular shaped cross-section and includes an upper segment 56 disposed over the top 30 of the back plate 24, a lower segment 58 disposed over the bottom 32 of the back plate 24 and a pair of flank segments 60 that extend between the upper and lower segments 56, 58 and are disposed over the sides 34 of the back plate 24. The plate frame 54 further defines a window 64 between the upper and lower and flank segments 56, 58, 60 for providing visibility to a license plate 25 disposed between the back plate 24 and the plate frame 54.

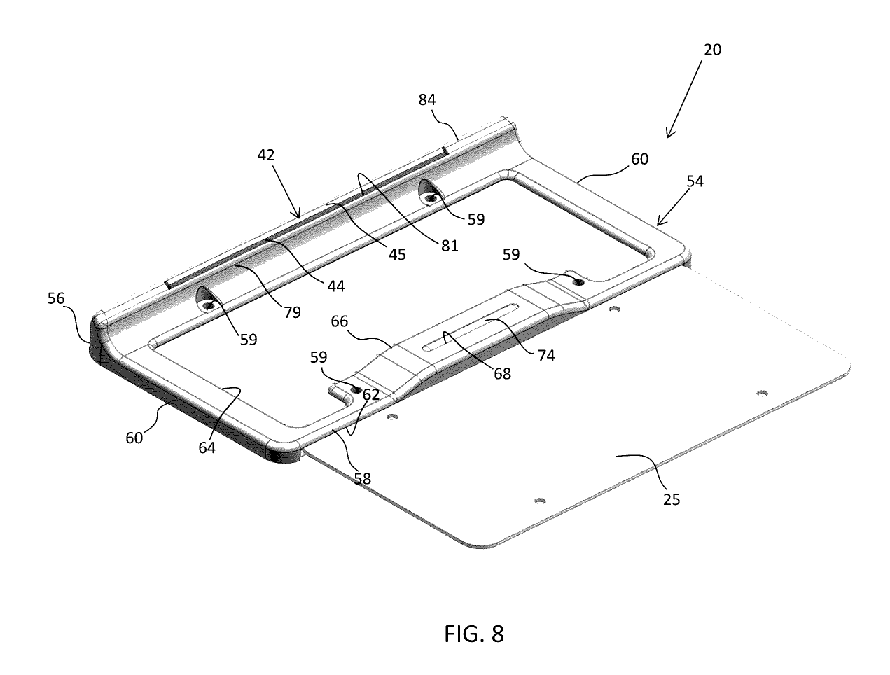

As best shown in FIG. 8, the bottom 32 of the back plate 24 and the lower segment 58 of the plate frame 54 define a plate slot 62 therebetween for receiving a license plate 25 between the back plate 24 and the plate frame 54. Said another way, a license plate 25 may be inserted into the assembly 20 through the plate slot 62.

As best shown in FIGS. 6 and 10, a plurality of connection orifices 59 are defined by the plate frame 54 and the back plate 24. A plurality of second fasteners 61 extend through the connection orifices 59 and the license plate 25 for connecting the assembly 20 and the license plate 25 to the vehicle 22. In the example embodiments, the second fasteners 61 are bolts; however, it should be appreciated that other types of fasteners could be utilized.

As best shown in FIGS. 6 and 7, a generally rectangular-shaped cover member 66 extends from the lower segment 58 into the window 64 toward the upper segment 56. The cover member 66 defines a linear slit 68 that extends parallel to the lower segment 58 of the plate frame 54.

A controller 70, 71, is electrically connected to the detector assembly 42 for processing information received by the array 44. In the first example embodiment, the controller includes a circuit board 70 that is disposed in alignment with the cover member 66 and is electrically connected to the array 44. The circuit board 70 includes a microprocessor 71 (schematically shown) for processing information received by the array 44.

A plurality of feedback light emitting diodes 72 are disposed against the circuit board 70 in alignment with the slit 68 and are electrically connected to the circuit board 70 for emitting light in response to the detection of movement by the array 44. A lens 74 is disposed between the circuit board 70 and the cover member 66 and overlies the feedback light emitting diodes 72 for holding the light emitting diodes 72 in place and for protecting the light emitting diodes 72 while allowing light from the light emitting diodes 72 to pass through the lens 74. The feedback light emitting diodes 72 may be capable or emitting light in a plurality of different colors in the manner heretofore described in connection with FIGS. 1-4. It should be appreciated that other light emitting devices could be utilized instead of light emitting diodes.

In addition to, or as an alternative to the feedback light emitting diodes 72, an audible device 73 (schematically shown) such as a speaker or piezo-electric element may also be disposed on the circuit board 70 or other location of the assembly to provide feedback to an operator of the vehicle 22 during use of the detecting mechanism 42.

A plurality of first ribbon wires 76 and a jumper board 78 extend between and electrically connect the circuit board 70 and the array 44. The first ribbon wires 76 extend along the lower and flank segments 58, 60 of the plate frame 54. A first potting material 82 is disposed between back plate 24 and ribbon wires 80 and jumper board 78 for damping vibrations between the back plate 24 and the array 44, first ribbon wires 76 and jumper board 78 and for holding the first ribbon wires 76 and jumper board 78 in place relative to the back plate 24.

As best shown in FIGS. 7 and 8, a support member 79 is disposed beneath and engages the first flange 36. The support member 79 extends between the flank segments 57 for supporting the first flange 36. A second flange 84 extends from the upper segment 56 of the plate frame 54 at the viewing angle a and overlies the first flange 36. The second flange 84 and the support member 79 define a detector slot 81 therebetween receiving the detector assembly 42 for protecting the detector assembly 42.

As best shown in FIG. 10, the back plate 24 defines a wire opening 88 adjacent to the bottom 32 of the back plate 24. A plurality of second ribbon wires 86 extend from circuit board 70 along the front surface 26 of the back plate 24 adjacent to the bottom 32 of the back plate 24 and through the wire opening 88 and across the rear surface 28 of the back plate 24. A second potting material 90 overlies the second ribbon wires 86 for damping vibrations of the plurality of second ribbon wires 86 and for holding the second ribbon wires 86 in place relative to the rear surface 28 of the back plate 24.

As best shown in FIGS. 6 and 7, a pocket insert 92 of a metal material is fixed to the rear surface 28 of the back plate 24 for being received by a mounting hole on the vehicle 22 for connecting the license plate bracket and sensor assembly 20 to the vehicle 22. The pocket insert 92 has a tube portion 94 that extends between a rearward end 96 and a forward end 98. A lip 100 extends outwardly from the forward end 98 of the tube portion 94 and fixedly engages the rear surface 28 of the back plate 24 for connecting the pocket insert 92 to the back plate 24. A lid 102 is disposed across the rearward end 96 of the tube portion 94 to close the rearward end 96. The lid 102 defines a passage 104 that extends therethrough.

The second ribbon wires 86 further extend through the passage 104 for allowing the second ribbon wires 86 to be connected to a computer of the vehicle 22 for electrically connecting the circuit board 70 to the computer of the vehicle 22. More specifically, the second wires 76, 80, 86 electrically connect the license plate bracket and sensor assembly 20 to the existing passive entry system of the vehicle 22.

During operation of the subject assembly 20, the microprocessor 71 is programmed to identify a recognizable, predetermined, position, motion or reflection base on a signal provided by the detector assembly 42 as heretofore described. Upon recognition of such a position, motion or reflection, the microprocessor 71 sends a signal to the computer of the vehicle to open the rear access door. In other words, the microprocessor 71 is configured to receive signals from the detecting mechanism 42, and to open the rear access door in response to the reception of a predetermined signal, e.g., a hand wave or foot wave, in front of the detecting mechanism 42.

The microprocessor 71 is further configured to cause the feedback light emitting diodes 72 to emit light in different colors to direct the operator to the proper position or motion to open the rear access door. For example, as the user approaches the side of the assembly 20, the feedback light emitting diodes 72 may initially be red. As the user moves a hand or foot toward the middle of the assembly, the feedback light emitting diodes 72 will change to amber, and finally to green to indicate actuation of an opening mechanism of the rear access door. Additionally or as an alternative, the audible device 73 may be activated to further guide the user to the proper position or through the proper predetermined movement to open the rear access door.

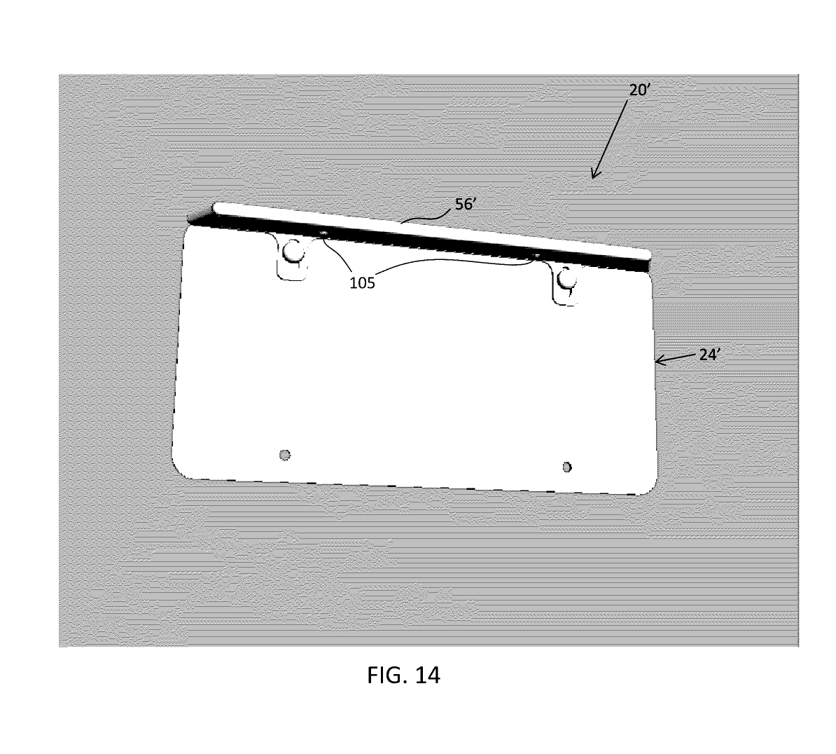

In the second example embodiment of the license plate bracket and sensor assembly 20′ presented in FIG. 14, the plate frame 54′ only extends across the top of the back plate 24′, such that only an upper portion of a license plate 25 is covered by the plate frame 54′. In this embodiment, the at least one controller may be incorporated into the upper segment 56′ of the plate frame 54′. Furthermore, a pair of visibility lights 105 are connected to the upper segment 56′ of the plate frame for 54′ illuminating the license plate 25 in the event that the assembly 20′ casts a shadow on the license plate 25 by blocking the factory installed lights of the vehicle 22. It should be appreciated that the first example embodiment of the assembly 20 could also include or more of such visibility lights 105.

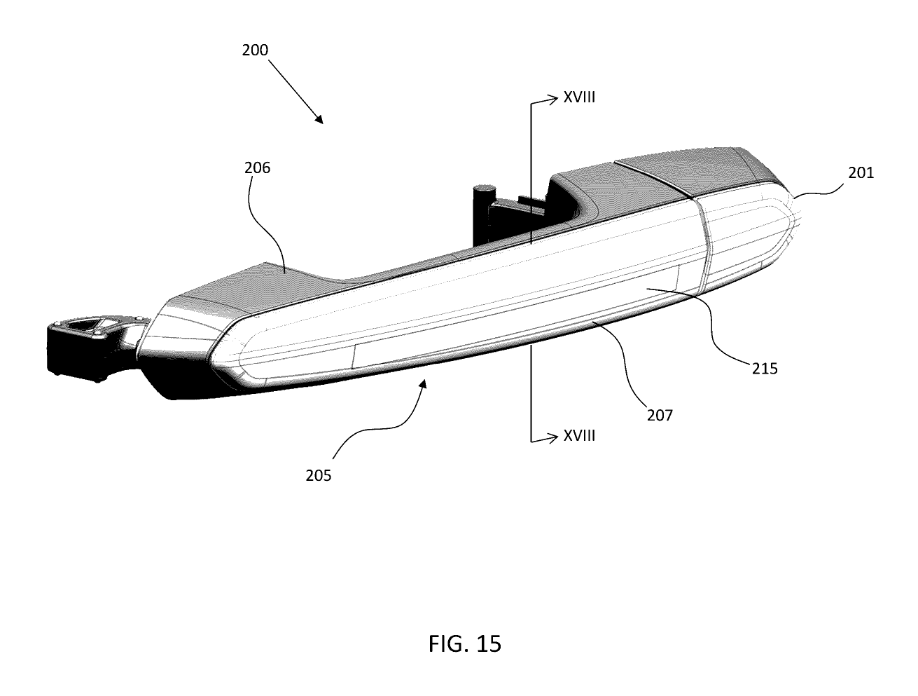

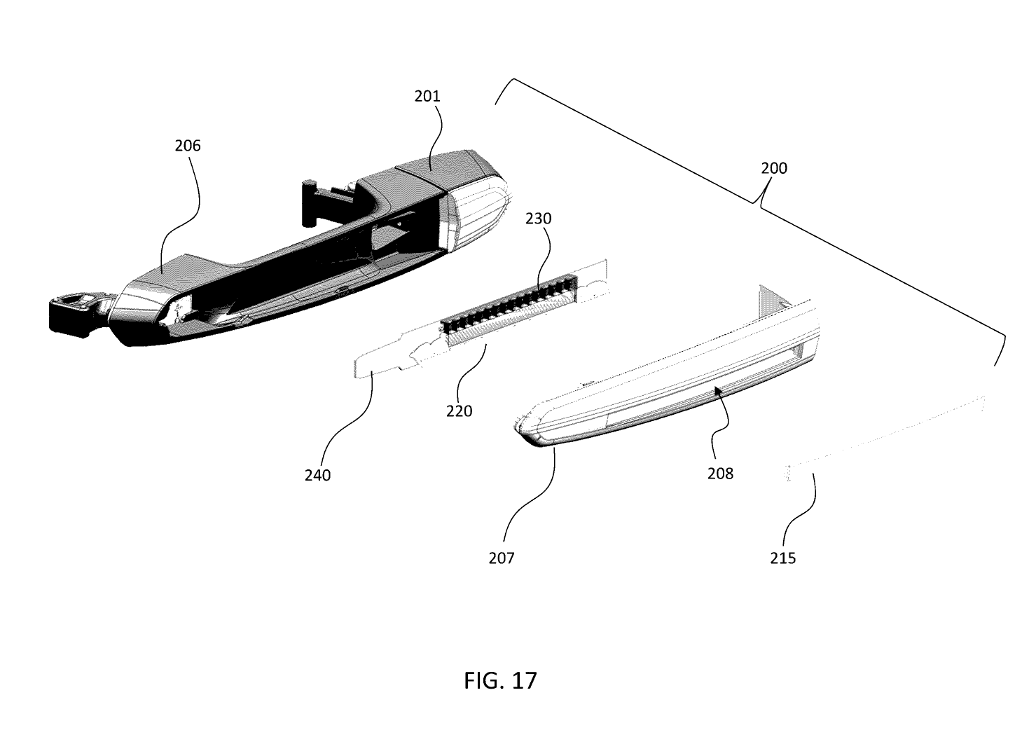

Turning now to FIGS. 15-18, there is shown an embodiment in which the present invention takes the form of a vehicle access handle 200 such as, for instance, of the type found on the driver-side and passenger doors of most conventional automobiles. Per convention, such a handle is a strap-style handle of the type comprising a base 201 fixed to the vehicle door and a moveable portion 205 adapted to be grasped by a user and pulled outwardly away from the door to release the door latch and, thus, open the door.

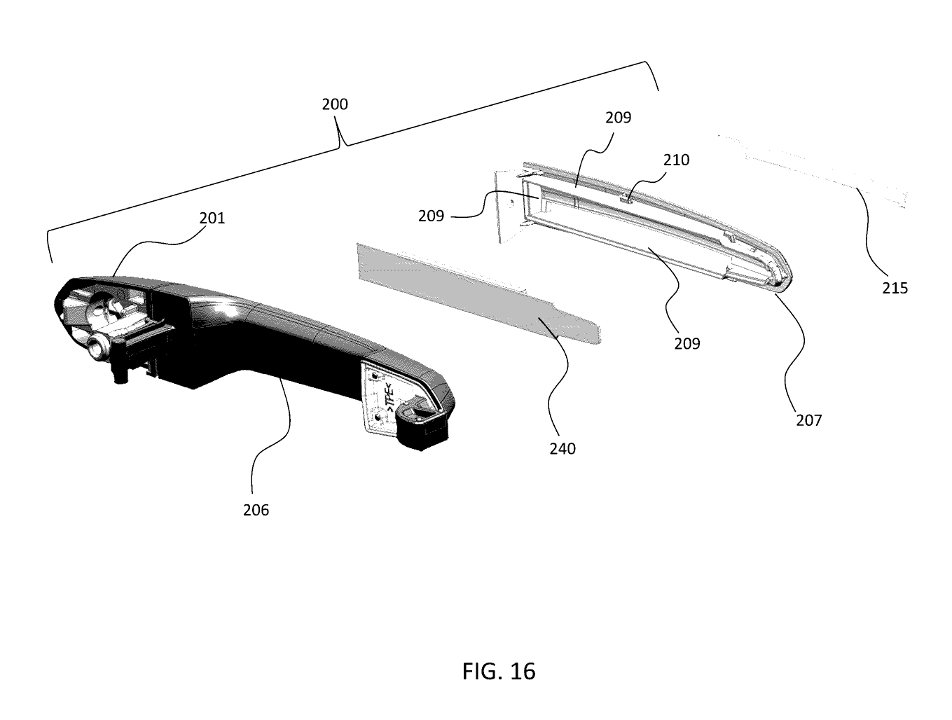

With particular reference to FIGS. 16-18, the moveable portion 205 of the access handle 200 comprises an inner, or base, part 206 and an outer, or cover, part 207 which is mated to the base part to define a housing for various components of the vehicle control system, as described further herein.

At least the IR detector assembly 220 and plurality of visible lights 230 are packaged within the moveable portion 205. To this end cover part 207 includes an opening 208 therein in which is mounted the lens 215. The lens 215 may be secured within the opening 208 in any known fashion. Lens 215 faces outwardly away from the vehicle door (not shown) so as to both permit the emission of IR light by the IR LEDs outwardly in the direction of a user approaching or positioned proximate the lens 215, and to permit the plurality of lights 230 to be visible to the user upon illumination thereof.

The at least one controller 225 may be positioned completely in the moveable portion 205 of the handle or, alternatively, may be positioned elsewhere on the vehicle and operatively connected to the IR detector assembly 220 and plurality of lights 230. In another form, the at least one controller 225 may comprise multiple components, such that a part of the at least one controller is positioned in the moveable portion 205 of the handle while the rest of the at least one controller is positioned elsewhere on the vehicle and operatively connected to the part in the moveable portion 205. Optionally, the at least one controller may be integrated as programming in the vehicle's onboard computer.

Per the illustrated embodiment, the IR detector assembly 220, plurality of lights 230, and the at least one controller 225 are all integrated on a single printed circuit board (PCB) 240 which is mounted within the moveable portion 205. Support member 211 is dimensioned to be sandwiched between the base 206 and cover 207 portions so that the PCB 240 is securely positioned within the housing defined by the handle moveable portion 205.

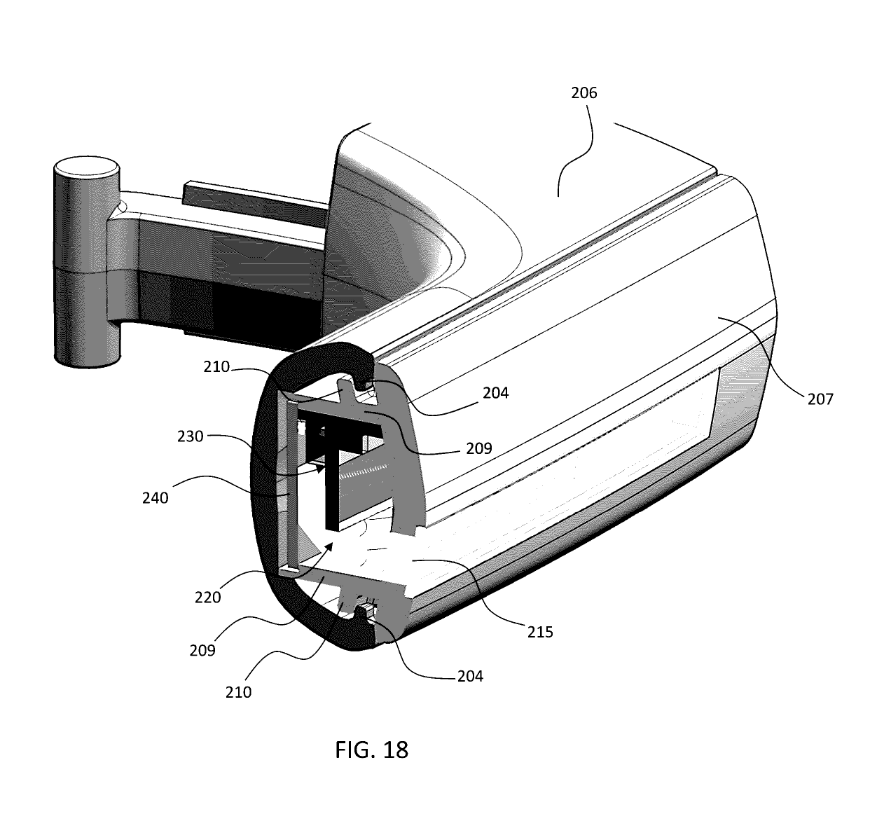

With particular reference to FIG. 18, secure positioning of the PCB 240 comprising the IR detector assembly 220, plurality of lights 230, and the at least one controller 225 is accomplished via a support member extending inwardly from the cover portion 207 so as to be positioned inside the moveable portion 205. Support member includes sidewalls 209 on which are disposed a plurality of outwardly facing locking tabs 210 which engage with corresponding locking tabs 204 defined on the base portion 206 to securely connect the cover 207 and base 206 portions. PCB 240 is sandwiched between the support member and the base portion 206, while the IR detector assembly 220 and the plurality of lights 230 are received between the sidewalls 209 of the support member.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A vehicle access system, comprising:
an infrared detector assembly for detecting an object within a sensing region of the infrared detector assembly;
at least one controller operatively connected to the infrared detector assembly, the at least one controller operative (i) to determine from inputs from the infrared detector assembly if a detected object exhibits a predefined gesture and, if the detected object exhibits a predefined gesture, (ii) to direct the execution of one or more pre-defined vehicle commands; and
a plurality of lights operatively connected to the at least one controller, the plurality of lights selectively illuminable to produce visible light in one or more colors, wherein one or more of the plurality lights (i) are selectively illuminated by the at least one controller to visibly indicate the detected presence of an object within the sensing region by the infrared detector assembly, and (ii) are selectively illuminated by the at least one controller to visibly indicate that the detected object exhibits a predefined gesture.

2. The vehicle access system of claim 1, wherein the one or more of the plurality of lights are selectively illuminated in a first color to visibly indicate the detected presence of an object within the sensing region by the infrared detector assembly, and are selectively illuminated in a second color to visibly indicate that the detected object exhibits a predefined gesture.

3. The vehicle access system of claim 1, wherein the one or more of the plurality of lights are (i) selectively illuminated in a first color to visibly indicate the detected presence of an object within an area of the sensing region where the infrared detector assembly cannot determine if the detected object exhibits a predefined gesture, (ii) selectively illuminated in a second color to visibly indicate the detected presence of an object within an area of the sensing region where the infrared detector assembly can determine if the detected object exhibits a predefined gesture, and (iii) selectively illuminated in a third color to visibly indicate that the detected object exhibits a predefined gesture.

4. The vehicle access system of claim 3, wherein the first color is red, the second color is amber, and the third color is green.

5. The vehicle access system of claim 1, wherein the plurality of lights comprise at least two lights.

6. The vehicle access system of claim 1, wherein the infrared detector assembly comprises an array of infrared light-emitting LEDs and an array of infrared light sensors for receiving reflected light from an object in the sensing region in accordance with a time sequence in which one or more of the infrared light-emitting LEDs is activated and outputting a plurality of reflected signals, and the plurality of lights comprise a number of LEDs equal to the number of infrared light-emitting LEDs.

7. The vehicle access system of claim 2, wherein the plurality of lights comprise at least two lights.

8. The vehicle access system of claim 3, wherein the plurality of lights comprise at least three lights.

9. The vehicle access system of claim 3, wherein the plurality of lights comprise at least one RGB LED.

10. A vehicle access system, comprising:
a license plate bracket having a housing for engaging a vehicle and supporting a license plate against the vehicle;
an infrared detector assembly, associated with the housing, for detecting an object within a sensing region of the infrared detector assembly;
at least one controller associated with the housing and operatively connected to the infrared detector assembly, the at least one controller operative (i) to determine from inputs from the infrared detector assembly if a detected object exhibits a predefined gesture and, if the detected object exhibits a predefined gesture, (ii) to direct the execution of one or more pre-defined vehicle commands; and
a plurality of lights associated with the housing and operatively connected to the at least one controller, the plurality of lights selectively illuminable to produce visible light in one or more colors, wherein one or more of the plurality lights (i) are selectively illuminated by the at least one controller to visibly indicate the detected presence of an object within the sensing region by the infrared detector assembly, and (ii) are selectively illuminated by the at least one controller to visibly indicate that the detected object exhibits a predefined gesture.

11. The vehicle access system of claim 10, wherein the at least one controller is operatively connectable to the rear access closure of a vehicle, and the one or more pre-defined vehicle commands includes opening the rear access closure of the vehicle.

12. The vehicle access system of claim 10, wherein the one or more of the plurality of lights are selectively illuminated in a first color to visibly indicate the detected presence of an object within the sensing region by the infrared detector assembly, and are selectively illuminated in a second color to visibly indicate that the detected object exhibits a predefined gesture.

13. The vehicle access system of claim 10, wherein the one or more of the plurality of lights are (i) selectively illuminated in a first color to visibly indicate the detected presence of an object within an area of the sensing region where the infrared detector assembly cannot determine if the detected object exhibits a predefined gesture, (ii) selectively illuminated in a second color to visibly indicate the detected presence of an object within an area of the sensing region where the infrared detector assembly can determine if the detected object exhibits a predefined gesture, and (iii) selectively illuminated in a third color to visibly indicate that the detected object exhibits a predefined gesture.

14. The vehicle access system of claim 13, wherein the first color is red, the second color is amber, and the third color is green.

15. The vehicle access system of claim 10, wherein the plurality of lights comprise at least two lights.

16. The vehicle access system of claim 10, wherein the infrared detector assembly comprises an array of infrared light-emitting LEDs and an array of infrared light sensors for receiving reflected light from an object in the sensing region in accordance with a time sequence in which one or more of the infrared light-emitting LEDs is activated and outputting a plurality of reflected signals, and the plurality of lights comprise a number of LEDs equal to the number of infrared light-emitting LEDs.

17. The vehicle access system of claim 12, wherein the plurality of lights comprise at least two lights.

18. The vehicle access system of claim 13, wherein the plurality of lights comprise at least three lights.

19. The vehicle access system of claim 13, wherein the plurality of lights comprise at least one RGB LED.

20. A vehicle access system, comprising:
a handle assembly for a vehicle access door, the handle assembly including a housing;
an infrared detector assembly, associated with the housing, for detecting an object within a sensing region of the infrared detector assembly;
at least one controller associated with the housing and operatively connected to the infrared detector assembly, the at least one controller operative (i) to determine from inputs from the infrared detector assembly if a detected object exhibits a predefined gesture and, if the detected object exhibits a predefined gesture, (ii) to direct the execution of one or more pre-defined vehicle commands; and
a plurality of lights associated with the housing and operatively connected to the at least one controller, the plurality of lights selectively illuminable to produce visible light in one or more colors, wherein one or more of the plurality lights (i) are selectively illuminated by the at least one controller to visibly indicate the detected presence of an object within the sensing region by the infrared detector assembly, and (ii) are selectively illuminated by the at least one controller to visibly indicate that the detected object exhibits a predefined gesture.

21. The vehicle access system of claim 20, wherein the at least one controller is operatively connectable to an access closure of a vehicle, and the one or more pre-defined vehicle commands includes locking and/or unlocking the access closure of the vehicle.

22. The vehicle access system of claim 20, wherein the one or more of the plurality of lights are selectively illuminated in a first color to visibly indicate the detected presence of an object within the sensing region by the infrared detector assembly, and are selectively illuminated in a second color to visibly indicate that the detected object exhibits a predefined gesture.

23. The vehicle access system of claim 20, wherein the one or more of the plurality of lights are (i) selectively illuminated in a first color to visibly indicate the detected presence of an object within an area of the sensing region where the infrared detector assembly cannot determine if the detected object exhibits a predefined gesture, (ii) selectively illuminated in a second color to visibly indicate the detected presence of an object within an area of the sensing region where the infrared detector assembly can determine if the detected object exhibits a predefined gesture, and (iii) selectively illuminated in a third color to visibly indicate that the detected object exhibits a predefined gesture.

24. The vehicle access system of claim 23, wherein the first color is red, the second color is amber, and the third color is green.

25. The vehicle access system of claim 20, wherein the plurality of lights comprise at least two lights.

26. The vehicle access system of claim 20, wherein the infrared detector assembly comprises an array of infrared light-emitting LEDs and an array of infrared light sensors for receiving reflected light from an object in the sensing region in accordance with a time sequence in which one or more of the infrared light-emitting LEDs is activated and outputting a plurality of reflected signals, and the plurality of lights comprise a number of LEDs equal to the number of infrared light-emitting LEDs.

27. The vehicle access system of claim 22, wherein the plurality of lights comprise at least two lights.

28. The vehicle access system of claim 23, wherein the plurality of lights comprise at least three lights.

29. The vehicle access system of claim 23, wherein the plurality of lights comprise at least one RGB LED.
